(19) United States
(12) Patent Application Publication
(10) Pub. No.: US 2009/0001646 A1
(43) Pub. Date: Jan. 1, 2009

(54) IMAGE FORMING APPARATUS

(75) Inventor: Yuzo Matsumoto, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/144,112

(22) Filed: Jun. 23, 2008

(30) Foreign Application Priority Data
Jun. 26, 2007 (JP) 2007-168068

(51) Int. Cl. B41F 13/64

(52) U.S. Cl. 270/18

(57) ABSTRACT

The present invention provides an image forming apparatus having a sheet feeder capable of reliably feeding a sheet without using a sensor.

A rotation number detector detects the number of rotation of a fan. A determining portion determines whether the number of rotations of the fan detected by the rotation number detector is in a predetermined range. If the determining portion determines that the number of rotations of the fan is in the predetermined range, a sucking/conveying belt is driven.

### BACKGROUND OF THE INVENTION

1. Field of the Invention

The present invention relates to an image forming apparatus, and more particularly, to an apparatus which blows air to a sheet to loosen the sheet and then supplies the sheet.

2. Description of the Related Art

As a conventional image forming apparatus such as a copying machine and a printer, there is an apparatus having a sheet feeder which separates sheets stacked on a sheet stacking portion one sheet by one sheet from the top sheet and supplies the sheets to an image forming portion. As such a sheet feeder, there is a so-called air-supply type sheet feeder which blows air to a pile of sheets stacked on a sheet stacking portion to float a plurality of sheets and separate them from one another and they, sucks the sheet by a sucking/conveying belt and supplies the sheets one sheet by one sheet (see Japanese Patent Application Laid-open No. 7-196187).

Here, when sheets are fed, the air-supply type sheet feeder first blows air to ends of sheets stacked on a tray by a loosening nozzle and a separation nozzle and separates the sheets one sheet by one sheet. Next, a sheet is sucked by a sucking/conveying belt disposed above and conveyed.

The air-supply type sheet feeder includes a suction duct for sucking a sheet on the sucking/conveying belt, and a suction fan disposed in the suction duct. When a sheet is sucked by the sucking/conveying belt, the suction fan is rotated and a shutter provided in the suction duct is opened. With this, a pressure in the suction duct becomes negative by the suction fan, and a sheet is sucked through suction holes formed in the sucking/conveying belt.

Especially when a sheet is so-called coat-paper which is frequently used for color copy and whose surface is coated with coating material, absorptivity (adsorption force between sheets) between sheets becomes 10 N or higher depending upon a temperature or moisture in using environment in some cases. In this case, two or more, sometimes ten or more sheets are collectively fed, and a paper jam may occur.

After floating heavy and large sheets having basis weight of 200 g/m² or more, in order to suck the sheets, extremely strong wind pressure is required only for loosening and floating the sheets even if there is no influence of suction by environment between the sheets.

In order to stably convey sheets, if the conveying operation is not started after the sucking/conveying belt reliably sucks the sheets, there is fear that a sheet drops from the sucking/conveying belt or a sheet is diagonally sucked. Since it is necessary to start conveying a sheet after the sheet is reliably sucked by the sucking/conveying belt irrespective of types of sheets, according to the conventional air-supply type sheet feeder, the fact that a sheet was reliably sucked was checked using the following methods:

1. A method in which it is determined that a sheet is sucked after preset time obtained by experiment or the like is elapsed after a suction shutter is turned ON.
2. A method in which a pressure in a suction duct is monitored using a pressure sensor, and it is determined that a sheet is sucked when the pressure becomes equal to a predetermined pressure (see Japanese Patent Application Laid-open No. 11-106071).

In the conventional image forming apparatus having the sheet feeder, if it is determined that a sheet is sucked after predetermined time is elapsed after the suction shutter is opened, since it is not apparent whether the sheet is reliably sucked, a feeding failure of sheet occurs in some cases. In order to prevent the feeding failure from occurring, it is necessary to increase the time, and there is a problem that the productivity (the number of sheets to be fed per unit time) is largely reduced.

According to the method in which it is determined that a sheet is sucked using the pressure sensor, since the expensive pressure sensor is used, there is a problem that the cost of the apparatus is increased.

The present invention has been accomplished in view of such circumstances, and it is an object of the invention to provide an image forming apparatus having a sheet feeder capable of reliably feeding sheets without using a sensor.

### SUMMARY OF THE INVENTION

The present invention provides an image forming apparatus comprising an air blowing portion which blows air to sheets stacked on a sheet stacking portion to loosen the sheets; a conveying belt which sucks the sheet loosened by the air blowing portion and conveys the sheet; a fan which generates an adsorption force in the conveying belt to suck the sheet; a rotation number detector which detects number of rotations of the fan; and a control unit which determines whether the number of rotations of the fan detected by the rotation number detector is in a predetermined range when air is blown to the sheets by the air blowing portion to loosen the sheets and the adsorption force is generated in the conveying belt by the fan, wherein if the control unit determines that the number of rotations of the fan is in the predetermined range, the control unit drives the conveying belt.

When it is determined that the number of rotations of the fan is in a predetermined range before the conveying belt is driven as in this invention, it is possible to reliably feed sheets without using a sensor by driving the sucking/conveying belt.

Further features of the present invention will become apparent from the following description of exemplary embodiments (with reference to the attached drawings).

### BRIEF DESCRIPTION OF THE DRAWINGS

FIG. 1 is a diagram illustrating an outline structure of a printer which is one example of an image forming apparatus having a sheet feeder according to a first embodiment of the present invention;

FIG. 2 is a diagram illustrating a structure of the sheet feeder;

FIG. 3 is an explanatory diagram of structures of a rear end restriction plate and a side end restriction plate provided on the sheet feeder;

FIG. 4 is a first diagram used for explaining sheet feeding motion of the sheet feeder;

FIG. 5 is a second diagram used for explaining the sheet feeding motion of the sheet feeder;

FIG. 6 is a third diagram used for explaining the sheet feeding motion of the sheet feeder;

FIG. 7 is a fourth diagram used for explaining the sheet feeding motion of the sheet feeder;

FIG. 8 is a control block diagram of the sheet feeder;

FIG. 9 is a diagram illustrating a relation between a PWM value (%) of a suction fan provided in the sheet feeder and a rotation signal frequency (Hz);

FIG. 10 is a diagram illustrating a relation between the rotation signal frequency of the suction fan and types of sheets;

FIG. 11A is a diagram illustrating variation in the number of rotations of the suction fan a thick paper is sucked by the sucking/conveying belt;

FIG. 11B is a diagram illustrating variation in a suction force of the suction fan a thick paper is sucked by the sucking/conveying belt;

FIG. 12 is a diagram illustrating a relation of the sheet feeder between a suction force required for king of sheet and a set PWM value;

FIG. 13 is a diagram illustrating an operation screen of a printer main body;

FIG. 14 is a diagram illustrating sheet feedable conditions of sheets of the sheet feeder;

FIG. 15 is a first timing chart for explaining of sheets by the sheet feeder;

FIG. 16 is a first timing chart for explaining control of a PWM value of the sheet feeder;

FIG. 17 is a second timing chart for explaining control of the PWM value of the sheet feeder;

FIG. 18 is a diagram for explaining a structure of a suction duct provided in the printer;

FIG. 19 is a second timing chart for explaining of sheets by the sheet feeder;

FIG. 20 is a third timing chart for explaining of sheets by the sheet feeder;

FIG. 21 is a flowchart for explaining the suction/conveying motion of the sheet feeder;

FIG. 22 are tables illustrating feeding conditions of a first motor of a sheet feeder according to a second embodiment of the invention;

FIG. 23 is a timing chart for explaining feeding condition changing motion of the sheet feeder; and

FIG. 24 is a flowchart for explaining the suction/conveying motion by the sheet feeder.

### DESCRIPTION OF THE EMBODIMENTS

Exemplary embodiments for carrying out the present invention will be explained in detail using the drawings.

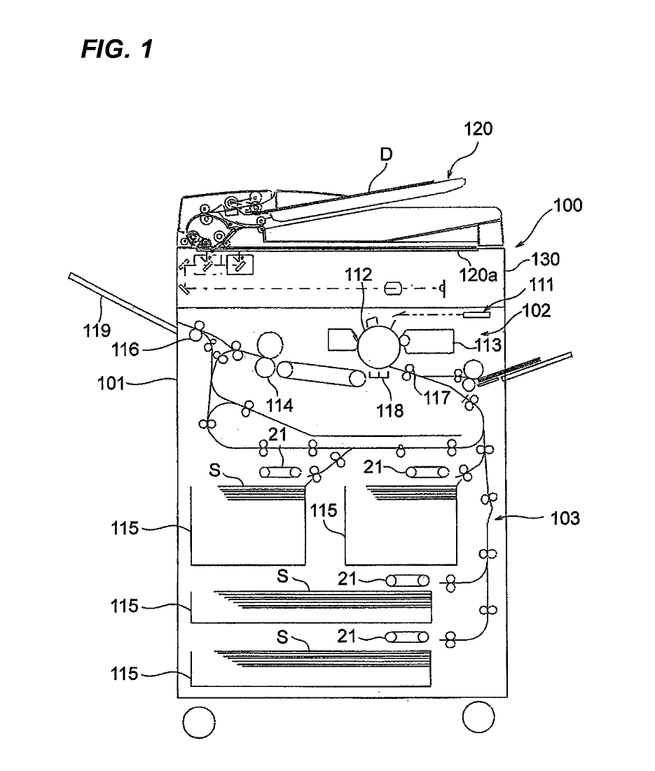

FIG. 1 is a diagram showing an outline structure of a printer which is one example of an image forming apparatus having a sheet feeder according to a first embodiment of the present invention.

FIG. 1 shows a printer 100 and a printer main body 101. An image reader 130 which reads an original D put on a platen glass 120a as an original placing platen by an automatic original feeder 120 is provided on an upper portion of the printer main body 101. An image forming portion 102 and a sheet feeder 103 which feeds sheets to the image forming portion 102 are provided below the image reader 130.

Here, the image forming portion 102 is provided with a photosensitive drum 112, a development device 113 and a laser scanner unit 111. The sheet feeder 103 includes a plurality of sheet accommodating portions 115 which can accommodate the sheets and which can be attached to and detached from the apparatus main body 101. The sheet feeder 103 also includes a sucking/conveying belt 21 which is a feeding belt as one example of a sheet feeding unit. The sheet feeding unit feeds sheets accommodated in the sheet accommodating portion 115.

Next, the image forming motion of the printer 100 having such a structure will be explained.

If an image reading signal is output to the image reader 130 from a control device (not shown) provided in the printer main body 101, an image is read by the image reader 130. Then, the photosensitive drum 112 is irradiated with laser light corresponding to the electric signal from the laser scanner unit 111.

At that time, the photosensitive drum 112 is previously charged, and if the photosensitive drum 112 is irradiated with light, an electrostatic latent image is formed, and if the electrostatic latent image is developed by the development device 113, a toner image is formed on the photosensitive drum 112.

If a feeding signal is output to the sheet feeder 103 from the control device, a sheet S is supplied from the sheet accommodating portion 115. Then, the sheet S is sent to a transfer portion constituting the photosensitive drum 112 and a transfer charger 118 in synchronization with a toner image on the photosensitive drum 112 by a resist roller 117.

Next, the toner image is transferred onto the sheet which is sent to the transfer portion, and the sheet S is conveyed to the fixing portion 114. Then, the sheet S is heated and pressurized by the fixing portion 114, and a non-fixed toner image is permanently fixed to the sheet S. The sheet S on which the image is fixed is discharged to a discharge tray 119 from the apparatus main body 101 by the d 116.

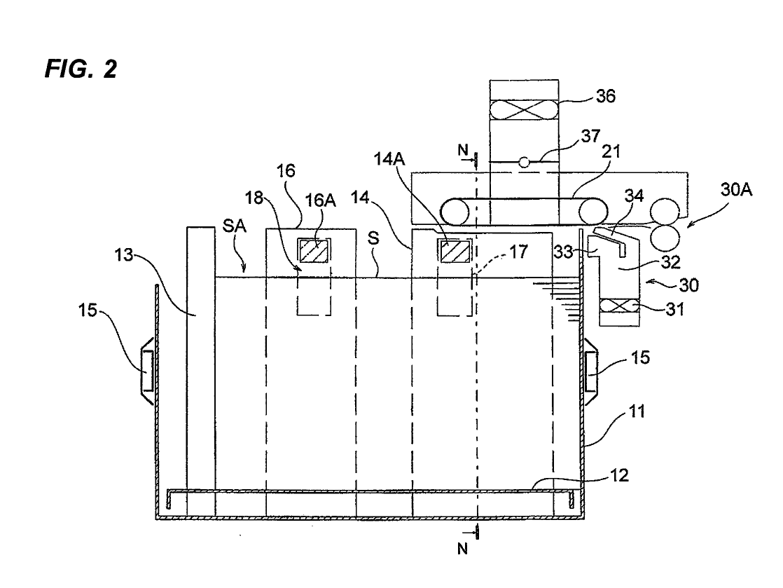

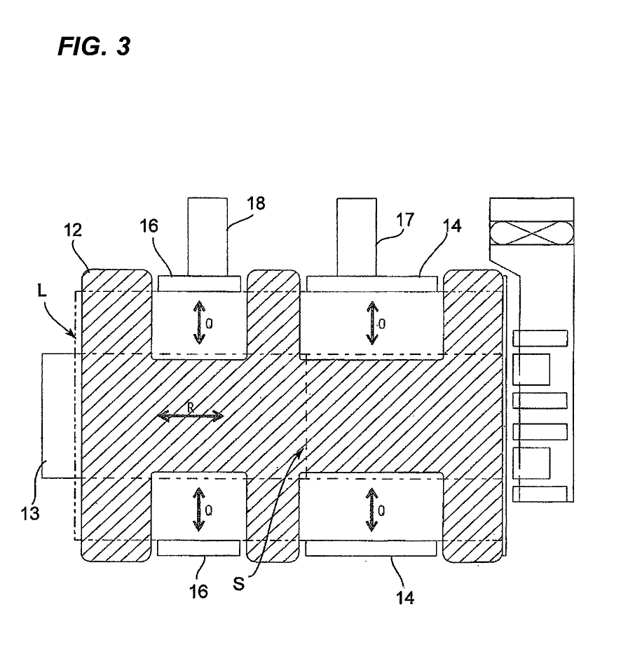

FIG. 2 shows a structure of the sheet feeder 103. In FIG. 2, a storage 11 is provided in the image forming apparatus main body (not shown) such that the storage 11 can be pulled out. The storage 11 includes a tray 12 which is a vertically movable sheet stacking portion on which a plurality of sheets (pile of sheets) are placed.

The image forming apparatus also includes a rear end restriction plate 13 which restricts a rear end position of a sheet S. The rear end of the sheet is an upstream end in the sheet feeding direction. The image forming apparatus also includes side end restriction plates 14 and 16 which restrict side end positions of the sheet S. The side ends of the sheet are ends of the sheet which intersects with the sheet feeding direction (widthwise direction, hereinafter). The image forming apparatus also includes a slide rail 15 which accommodates the storage 11 such that the storage 11 can be pulled out from the image forming apparatus main body (not shown).

Positions of the rear end restriction plate 13 and the side end restriction plates 14 and 16 can freely be changed in directions Q and R in FIG. 3 in accordance with size of sheets. In FIG. 3, phantom lines show positions of the rear end restriction plate 13 and the side end restriction plates 14 and 16 when a sheet is of minimum size.

As apparent also from FIG. 3, the tray 12 has a shape as shown with a hatch pattern so that sheets from large size to small size can stably be held. The two side end restriction plates 14 and 16 are divided for this reason.

As shown in FIG. 2, auxiliary separation fans 17 and 18 are mounted to the side end restriction plates 14 and 16, respectively so that air can be blown to a pile SA of sheets from openings 14A and 16A. The side end restriction plates 14 and 16 are provided with the auxiliary separation fans 17 and 18 in this manner, it is possible to more reliably float and separate sheets.

In FIG. 2, a suction/conveying portion 30A comprises a separation duct 32 having a separation fan 31, a loosening nozzle 33 and a separation nozzle 34. The suction/conveying portion 30A also includes an air blowing portion 30 which blows air to the sheet S to loosen the sheet S. The suction/conveying portion 30A includes a suction fan 36, a suction shutter 37 and the sucking/conveying belt 21 which sucks and conveys a sheet. FIG. 2 shows a state where after a user pulled out the storage 11, the user sets sheets and again accommodates the storage 11 into the image forming apparatus main body.

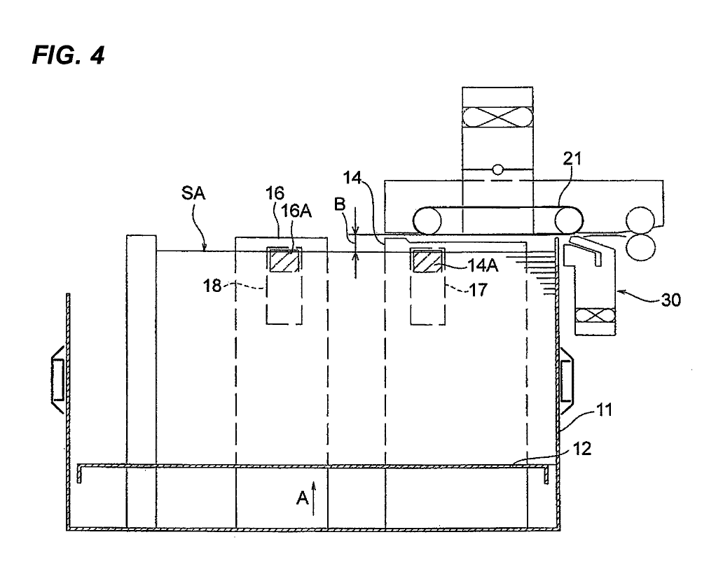

If the storage 11 is accommodated in which manner, the tray 12 starts moving upward in the direction shown with the arrow A in FIG. 4 by a driving unit (not shown), the tray 12 stops at a position where a distance between an upper surface of the pile SA of sheets on the tray and the sucking/conveying belt 21 becomes equal to B, and the image forming apparatus is ready for a feeding signal.

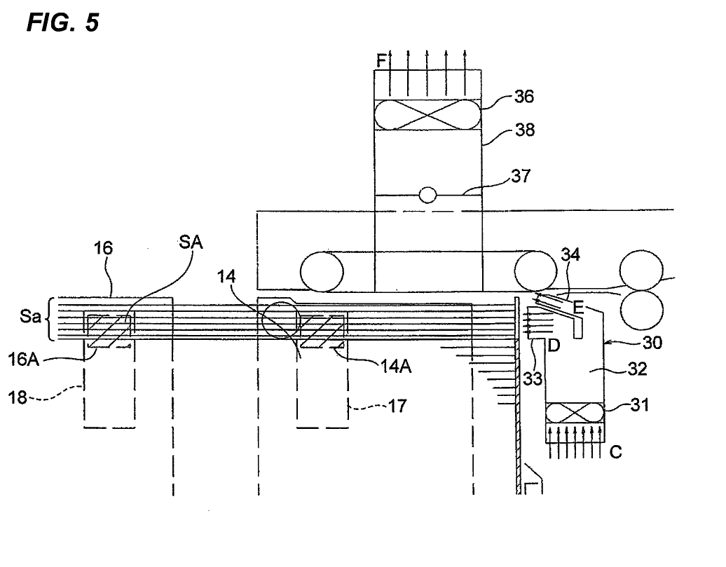

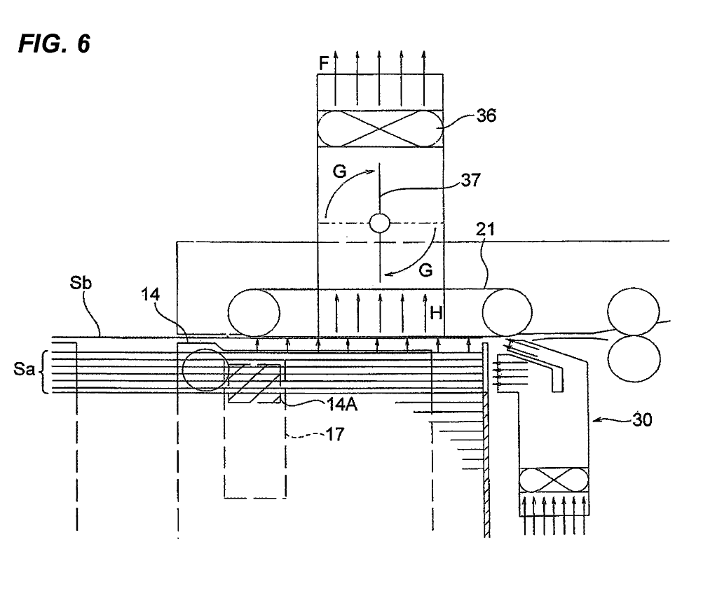

Next, if the feeding signal is input, the separation fan 31 operates, and air is sucked in a direction shown with the arrow C in FIG. 5. Air is blown to the pile SA of sheets from the directions D and E from the loosening nozzle 33 and the separation nozzle 34, respectively, via the separation duct 32 and with this, some sheets of the pile SA located at upper portions float up. The suction fan 36 is operated and air is discharged in the direction F shown in the drawing. At that time, the suction shutter 37 is still closed. The separation fan 31 and the suction fan 36 may start at the same time or either one of them may start first.

Then, when predetermined time is elapsed after the feeding signal is detected and several sheets float up and stabilized, the suction shutter 37 is rotated in the direction of the arrow G. With this, a suction force in the direction H in the drawing is generated from suction holes (not shown) formed in the sucking/conveying belt 21 by a negative pressure in the suction duct 38, and the top sheet Sb (top sheet, hereinafter) of the several floating sheets Sa is sucked by the sucking/conveying belt 21.

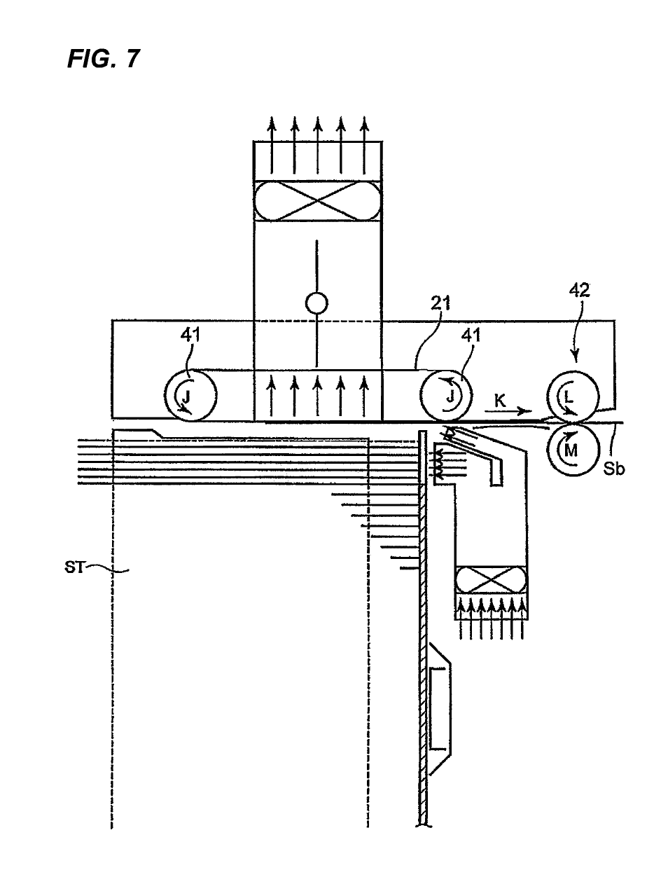

Next, after the top sheet Sb is sucked, a belt drive roller 41 around which the sucking/conveying belt 21 is wound is rotated in the direction of the arrow J as shown in FIG. 7, thereby rotating the sucking/conveying belt 21, and the top sheet Sb is conveyed in the direction of the arrow K. Then, finally, the top sheet Sb is pulled out from the sucking/conveying belt 21 by a pair of pull-out rollers 42 which rotates in the directions L and M and then, the top sheet Sb is conveyed to a next conveyance path.

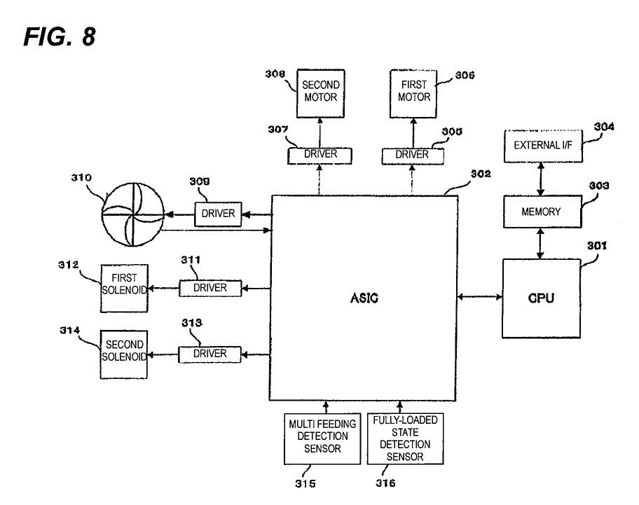

FIG. 8 is a control block diagram showing control unit of the sheet feeder 103. A CPU 301 controls the sheet feeder 103. A special ASIC 302 which drives various loads of the sheet feeder 103 such as a motor and a fan is connected to the CPU 301. A memory 303 which stores therein a threshold table of the number of rotations of the fan for determining whether it is possible to feed sheets in accordance with type of sheets is connected to the CPU 301.

Tables of an actuation speed, an acceleration and a conveying speed of the sucking/conveying belt 21 which are changed in accordance with the number of rotations of the fan are stored in the memory 303 which is a storage unit as will be described later. An external I/F (Interface) 304 is connected to the memory 303. The external I/F 304 is an operation screen through which a type of sheets, settings and operation starts are input.

In FIG. 8, a suction fan motor 310 is a drive portion which rotates the suction fan 36, and a driver 309 drives the suction fan motor 310. The CPU 301 and the ASIC 302 compute speed calculation and comparison calculation of the suction fan 36.

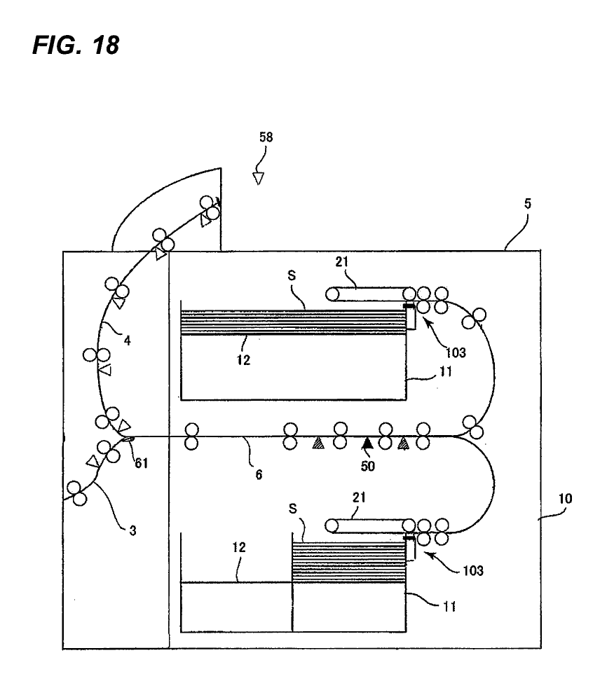

A first solenoid 312 drives the suction shutter 37, a driver 311 drives the first solenoid 312, a second solenoid 314 drives a flapper 61 shown in FIG. 18, and a driver 313 drives the second solenoid 314. A first motor 306 drives the belt drive roller 41, and a driver 305 drives the first motor 306.

A second motor 308 drives a roller which conveys sheets to an escape conveying path shown in FIG. 18, and a driver 307 drives the second motor 308. The image forming apparatus also includes a multi feeding detection sensor 315 and a fully-loaded state detection sensor 316.

Although the special ASIC 302 controls various loads of the sheet feeder 103 such as a motor and a fan in the present embodiment, the CPU 301 may control the various loads.

Next, the control of the number of rotations of the suction fan 36 by a control unit of the present embodiment will be explained.

In this embodiment, a rotation number signal is output to the suction fan 36, and the number of rotations is controlled by PWM (Pulse Width Modulation) control. If the image forming apparatus is operated with 24 V at PWM 100%, a pulse signal of 200 Hz is output as the rotation number signal.

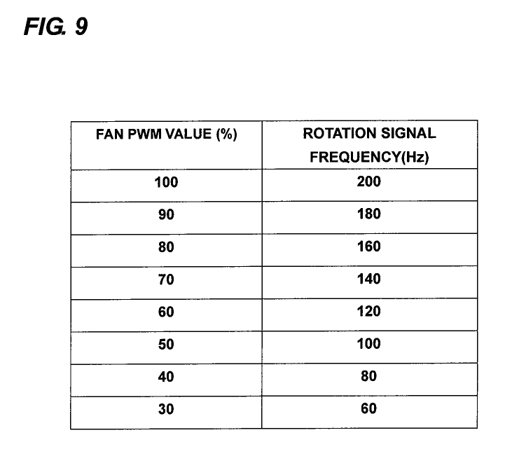

FIG. 9 is a diagram showing a relation between a PWM value (%) of the suction fan provided and a rotation signal frequency (Hz). If the PWM value of the suction fan is changed, the rotation signal frequency of the suction fan is also changed. Basically, the PWM value of the suction fan and the rotation signal frequency are proportional to each other, and some suction fans can not be actuated with less than predetermined PWM value. Although the number of rotations of the suction fan is explained using the rotation signal frequency in this embodiment, this is not limited only if the number of rotations of the suction fan can be detected.

A sheet S is sucked by the sucking/conveying belt 21 when predetermined time is elapsed after the suction shutter 37 is turned ON. The suction force (internal pressure) of the sheet S by the suction fan 36 at that time is varied depending upon types of sheets. For example, it is found, as a result of search of the present inventor, that a sheet of a type having smaller basis weight has higher suction force as compared with a sheet of a type having greater basis weight.

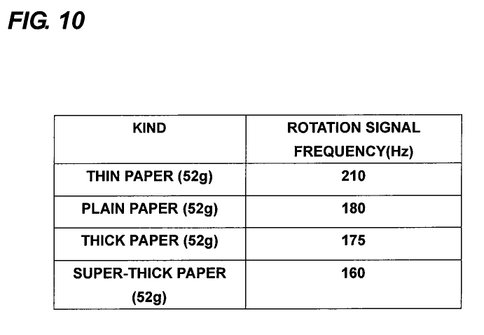

FIG. 10 shows a relation between types of sheets and a rotation signal frequency of the suction fan 36 after the sheet S is sucked by the sucking/conveying belt 21 when predetermined time is elapsed after the suction shutter 37 is turned.

For example, a rotation signal frequency is 210 Hz in a thin paper (52 g), a rotation signal frequency is 180 Hz in a plain paper (105 g), a rotation signal frequency is 175 Hz in a thick paper (250 g), and a rotation signal frequency is 160 Hz in a super-thick paper (300 g). It is found from this that a thin paper has higher adsorption force than the thick paper.

According to a result of research of the present inventor, when a fan is used, a relation between a rotation signal frequency (f) of the suction fan 36 and a suction force (internal pressure) (P) in the suction duct 38 when a sheet is sucked by the sucking/conveying belt 21 is as follows. Values of constants A and B in the following calculation equation are varied when another shape of the suction duct, and another fan, and another pressure sensor are used. A unit of f is [Hz] and a unit of P is [Pa].

P=A×f−B (where, A and B are constants)

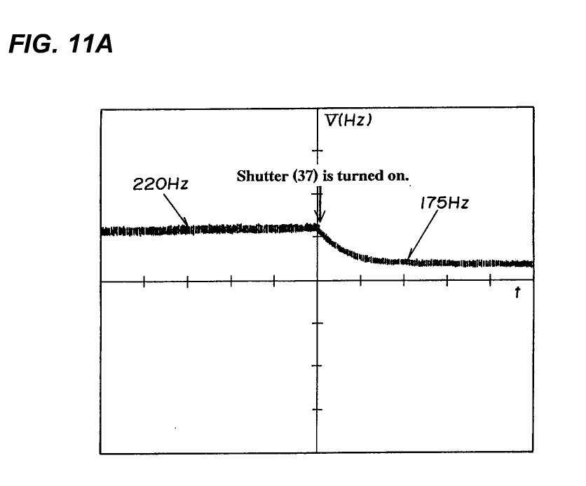

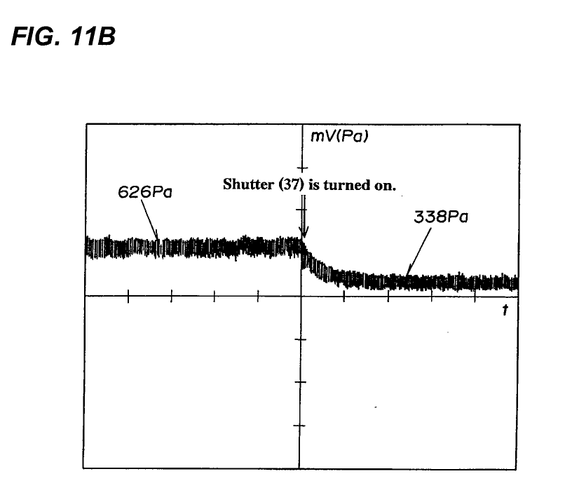

FIGS. 11A and 11B are diagrams showing a relation between the number of rotations of the suction fan 36 and the suction force (internal pressure) in the suction duct 38 when the sucking/conveying belt 21 sucks a thick paper 250 g. FIG. 11A is a graph in which a lateral axis shows a time axis and a vertical axis shows a voltage axis corresponding to the rotation signal frequency (Hz) of the suction fan. FIG. 11B is a graph in which a lateral axis shows a time axis and a vertical axis shows a voltage axis corresponding to a pressure (Pa) in the suction duct. If FIGS. 11A and 11B are compared with each other, it is found that both the number of rotations of the suction fan 36 and the internal pressure in the suction duct 38 are varied in the same manner before and after the suction shutter 37 is turned ON.

If FIGS. 11A and 11B are compared with each other, it is found that change tendencies of both the number of rotations of the suction fan 36 and the suction force (internal pressure) in the suction duct 38 are substantially matched with each other, and the suction force (internal pressure) in the suction duct 38 can be estimated by using the number of rotations of the suction fan 36 as a replacement.

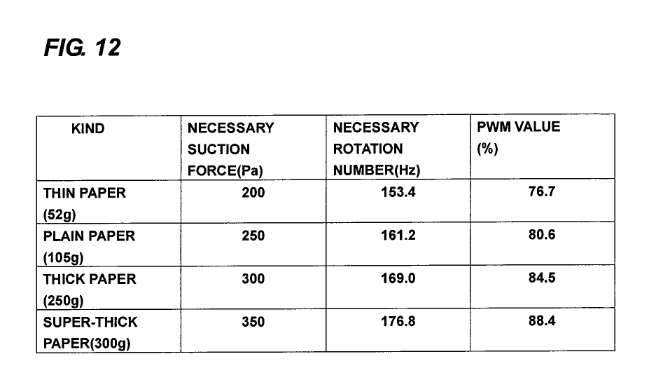

If a suction force (i.e., pressure in the suction duct 38) required for the type is determined as shown in FIG. 12, a necessary rotation signal frequency of the suction fan 36 and a necessary PWM value are determined by the above-mentioned calculation equation.

That is, since a suction force (duct internal pressure) required for the thin paper (52 g) is 200 Pa, a set PWM value is 76.7(%), and since a suction force (duct internal pressure) required for the plain paper (105 g) is 250 Pa, a set PWM value is a set PWM value is 80.6(%). Further, since a suction force (duct internal pressure) required for the thick paper (250 g) is 300 Pa, a set PWM value is 84.5(%), and since a suction force (duct internal pressure) required for the super-sick paper (300 g) is 250 Pa, a set PWM value is a set PWM value is 88.4(%).

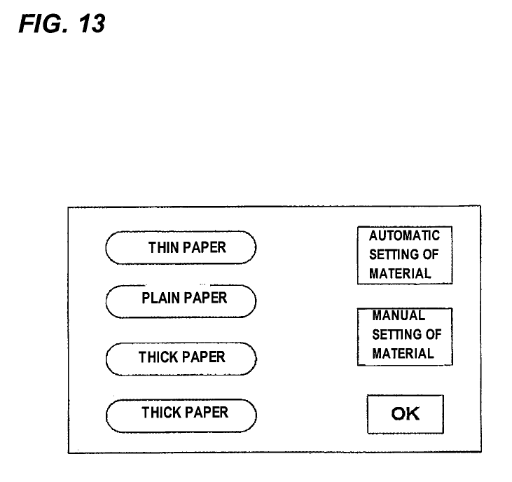

Therefore, in order to reliably suck and convey the sheet S, it is necessary that the suction force has a value suitable for a type of the sheet. Hence, in this embodiment, an external I/F 304 is constituted, and a type of sheet is set by an operation screen of the printer main body 101 shown in FIG. 13 which is a type setting portion which sets a type of sheet.

The ASIC 302 which functions as a rotation number setting portion in accordance with a type of sheet set by the operation screen (external I/F 304) sets a PWM value such that the number of rotations of the suction fan 36 falls in a range which is predetermined in accordance with such a type that a sheet can be sucked and conveyed.

However, the PWM value which is set by the operation screen of the printer main body 101 is an initial setting of the suction fan 36 which is set in accordance with a type of sheet. Therefore, the ASIC 302 finely adjusts the PWM value and controls the suction fan motor 310 (see FIG. 8) such that the number of rotations of the suction fan 36 falls within a range which is predetermined in accordance with a type of sheet while taking variation of the suction fan itself and variation of mounting of the suction and machine into consideration.

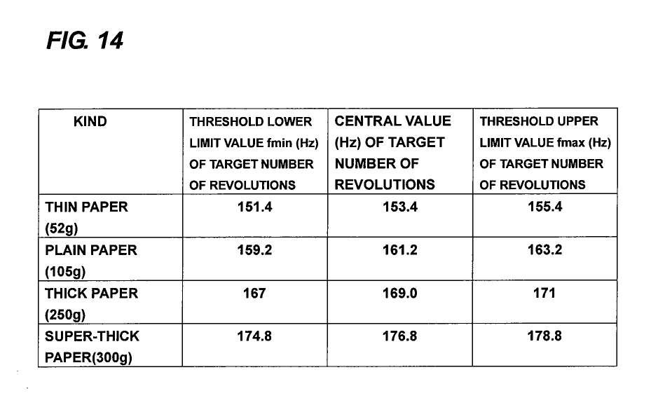

FIG. 14 shows conditions under which a sheet Sb sucked by the sucking/conveying belt 21 can be fed by the belt drive roller 41. For example, if the number of rotations of the suction fan 36 is in target number of rotations of the suction fan 36 ±2 Hz, it is determined that suction force and conveying force are sufficient and the control is performed such that the conveyance of a sheet is permitted.

When a predetermined time is elapsed after the suction shutter 37 is turned ON, if a rotation signal frequency of the suction fan 36 after a sheet Sb is sucked by the sucking/conveying belt 21 does not fall within the target range, the speed of the suction fan 36 is controlled to a target value. Here, the speed of the suction fan 36 may be controlled such that the PWM value is varied by a predetermined value, or a difference between the current number of rotations of the fan and a target number of rotations of the fan is multiplied by a given coefficient, and the obtained value is added to (or subtracted from) the PWM value of the fan.

When a speed of the suction fan 36 is controlled, the PWM value does not reach the threshold lower limit value of the target number of rotations even if the PWM value becomes 100% in some cases. In such a case, it is determined that a sufficient suction conveyance force can not be obtained, and the feeding operation is stopped to prevent a feeding failure. In some case, alarm or error may be indicated on the operation screen as shown in FIG. 13.

On rare occasion, the PWM value exceeds a threshold upper limit value of the target number of rotations. In such a case, damage on a sheet is taken into account and control is performed such that the feeding operation is stopped. Alternatively, when the image forming apparatus includes a later-described escape conveying path as shown in FIG. 18, a sheet is conveyed toward the escape conveying path. When the feeding operation is topped, alarm may be displayed on the operation screen as shown in FIG. 13 to remove a subject sheet.

Next, control of a rotation signal frequency of the suction fan 36 will be explained.

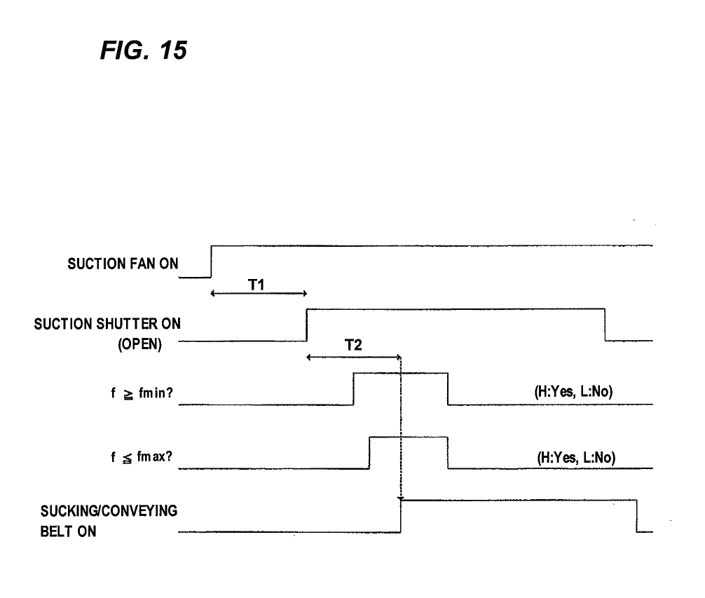

First, suction/conveying motion of sheets of the sheet feeder 103 in this embodiment will be explained using a timing chart shown in FIG. 15.

First, the suction fan 36 is driven (ON) and after predetermined time T1 (s) is elapsed, control is performed such that the suction shutter 37 is turned ON to open the suction shutter 37. Next, the suction shutter 37 is opened and after predetermined time T2 (s) is elapsed, a rotation signal frequency f of the suction fan 36 is detected in the CPU 301 and the ASIC 302 as described above.

Here, if the threshold lower limit value of the target number of rotations is defined as fmin and the threshold upper limit value of the target number of rotations is defined as fmax, if the detected rotation signal frequency f of the suction fan 36 is in a range of fmin≦f≦fmax, the sucking/conveying belt 21 is rotated. With this, a sheet is sucked by the sucking/conveying belt 21 and then, the sheet is conveyed with rotation of the sucking/conveying belt 21. Although a feeding state of the first sheet is illustrated in FIG. 15, when a plurality of sheets are to be fed, ON and OFF operations of the suction shutter 37, comparison of the rotation signal frequency and ON and OFF operations of the sucking/conveying belt 21 are repeated while keeping the operation state of the suction fan 36.

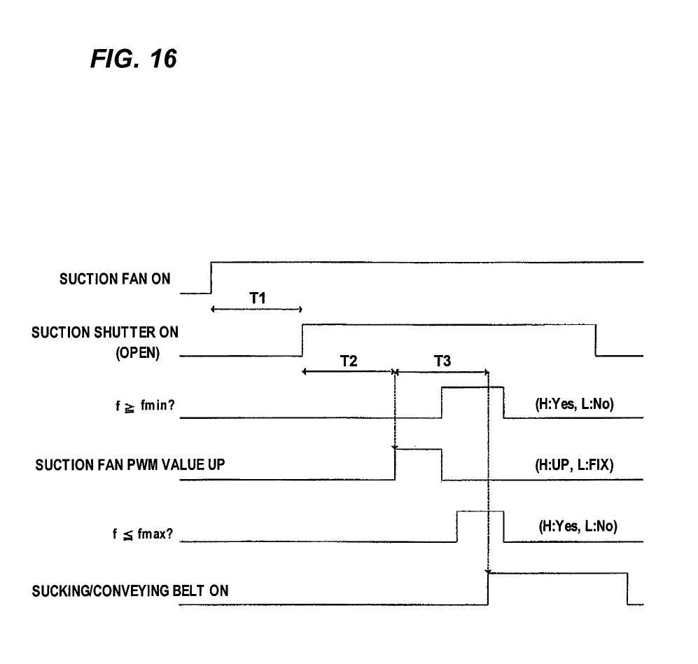

Next, control of the PWM value of the suction fan 36 when the rotation signal frequency f of the suction fan 36 does not become equal to or higher than fmin after the predetermined time T1 (s) and predetermined time T2 (s) are elapsed will be explained using a timing chart shown in FIG. 16.

In this case, i.e., when the rotation signal frequency f of the suction fan 36 does not become equal to or higher than fmin, control is performed such that the PWM value of the suction fan 36 is increased (UP) by a predetermined value, or a value obtained by multiplying a shortage by a given coefficient. Then, the PWM value of the suction fan 36 is increased and if the rotation signal frequency f becomes equal to or higher than fmin and equal to or lower than fmax after predetermined time T3 (s) is elapsed, control is performed such that the sucking/conveying belt 21 is rotated and a sheet sucked by the sucking/conveying belt 21 is fed and conveyed. Although a feeding state of the first sheet is shown in FIG. 16, if a plurality of sheets are to be fed, ON and OFF operations of the suction shutter 37, comparison of the rotation signal frequency and ON and OFF operations of the sucking/conveying belt 21 are repeated while keeping the operation state of the suction fan 36.

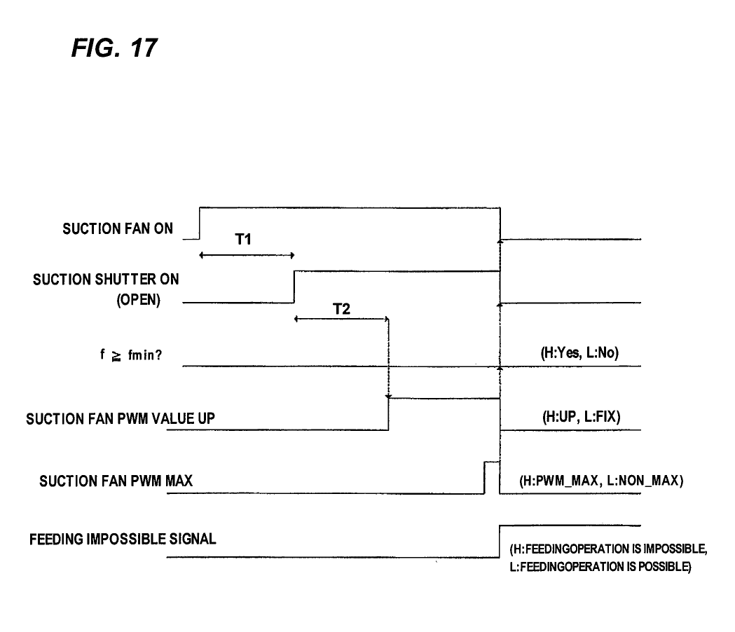

When the rotation signal frequency f of the suction fan 36 is lower than fmin in this manner, if control is performed such that the PWM value of the suction fan 36 is increased, the PWM becomes 100% in some cases. In this case, i.e., if the rotation signal frequency f does not become equal to or higher than fmin even if the PWM becomes the maximum 100%, control is performed such that the suction fan 36 and the suction shutter 37 are stopped at the same time when a feeding-impossible signal is output as show in FIG. 17.

On the other hand, f becomes greater than the threshold upper limit value of the target number of rotations fmax in some cases. In such a case, it is determined that the suction force of a sheet becomes greater than a predetermined suction force. When the suction force of a sheet is greater than the predetermined suction force, since damage on a sheet is great, the feeding operation is stopped. When the printer 100 includes a sheet deck 10 having the escape conveying path 4 which is a sheet discharge passage, a sheet having serious damage is stacked on the sheet stacking portion 5 from the escape conveying path 4.

FIG. 18 shows the multi feeding detection sensor 50, the conveying path 3 through which a sheet is conveyed toward the printer main body 101, the flapper 61 which switches the conveying direction of sheets to the escape conveying path 4 or the conveying path 3, and a fully-loaded state detection sensor 58 which detects a fully-loaded state of the sheet stacking portion 5.

In the sheet deck 10 having such an escape conveying path 4, if the conveying operation of the sheet is started by the sheet feeder 103, the multi feeding detection sensor 50 first detects the multi feeding of sheets. Here, the multi feeding of sheets is not detected, the flapper 61 is not switched, and a sheet S is conveyed to the conveying path 3.

If the multi feeding detection sensor 50 detects the multi feeding of sheets and the fully-loaded state detection sensor 58 does not detect the fully-loaded state of the sheet stacking portion 5, the flapper 61 is switched, and a sheet is conveyed to the escape conveying path 4. Then, the sheet conveyed to the escape conveying path 4 is stacked on the sheet stacking portion 5.

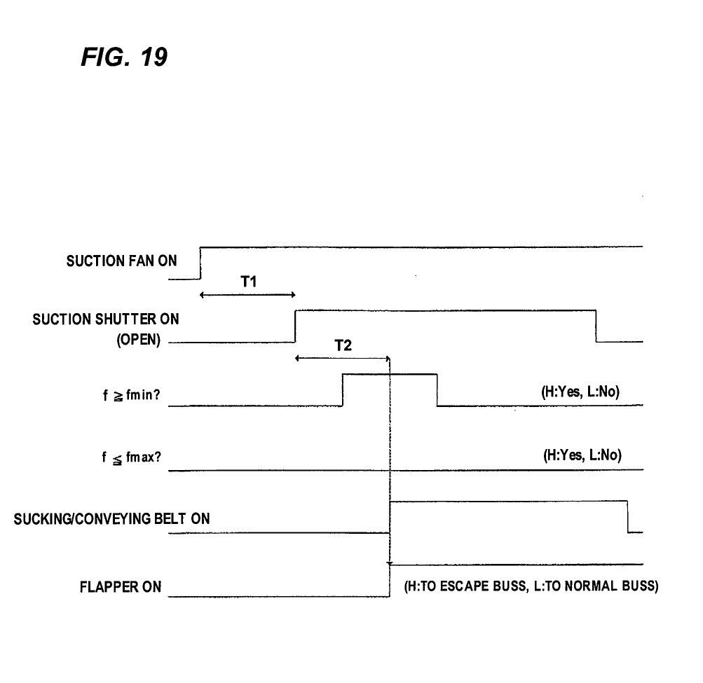

Next, the suction/conveying motion of a sheet when the rotation signal frequency f is higher than fmax will be explained using a timing chart shown in FIG. 19.

First, control is performed such that the suction shutter 37 is turned ON and the suction shutter 37 is opened when predetermined time T1 (s) is elapsed after the suction fan 36 is driven (ON). Next, when predetermined time T2 (s) is elapsed after the suction shutter 37 is opened, a rotation signal frequency f of the suction fan 36 is detected.

Here, the rotation signal frequency f of the suction fan 36 becomes equal to or greater than fmin, if a signal indicative of f≦fmax is not output, the flapper 61 is operated (ON) through the second solenoid 314 shown in FIG. 8. At the same time, control is performed such that a sheet sucked by the sucking/conveying belt 21 is fed and conveyed. With this, the sheet is conveyed to the escape conveying path 4.

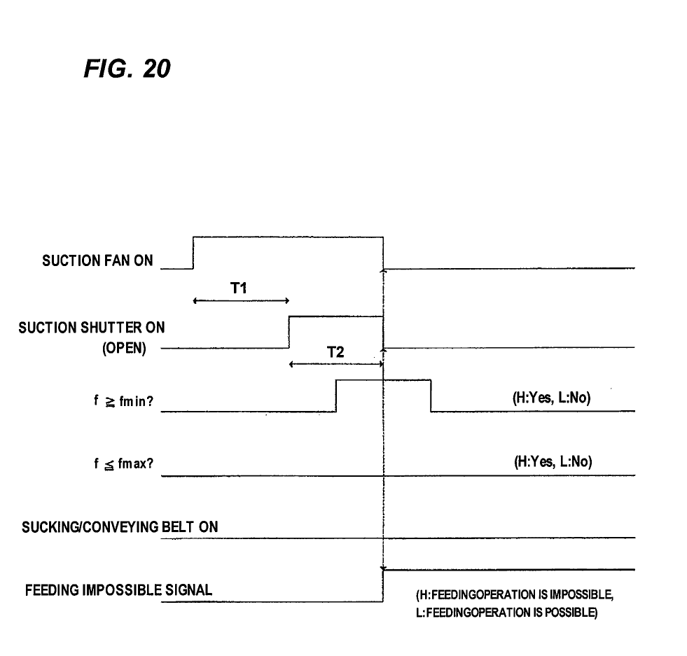

The rotation signal frequency f of the suction fan 36 becomes equal to or smaller than fmin as shown in FIG. 20, but if a signal indicative of f≦fmax is not output, control may be performed such that a feeding-impossible signal is output and at the same time the suction fan 36 and the suction shutter 37 are stopped.

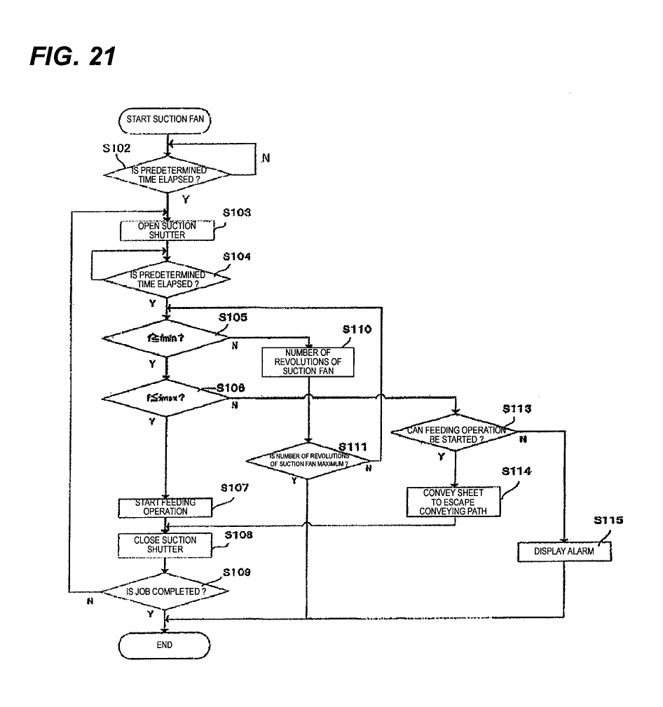

Next, a suction/conveying motion by the sheet feeder will be explained using a flowchart shown in FIG. 21.

First, if a feeding-start signal is received, the ASIC 302 (CPU 301) controls such that the suction fan 36 and the loosing fan 31 rotate at predetermined set values. Next, if predetermined time is elapsed (Y in S102), control is performed such that the suction shutter 37 is opened (S103).

Here, if the suction shutter 37 is opened, only the top sheet of the plurality of sheets loosened by the loosing fan 31 is sucked by the sucking/conveying belt 21 above the sheets stacked on the tray 12. Then, if the suction shutter 37 is opened and predetermined time is elapsed (Y in S104), the ASIC 302 first functions as a rotation number detector, and detects a rotation signal frequency f of the suction fan 36 corresponding to the number of rotations of the suction fan 36 mounted in the suction duct.

Next, the ASIC 302 functions as a determining portion which determines whether the detected rotation signal frequency f (number of rotations) of the suction fan 36 is within a predetermined range, and determines whether the detected rotation signal frequency f of the suction fan 36 is equal to or higher than the threshold lower limit value fmin of the target number of rotations (S105).

Here, if the rotation signal frequency f of the suction fan 36 is equal to or higher than the threshold lower limit value fmin of the target number of rotations (Y in S105), it is determined that the rotation signal frequency reaches the predetermined suction force, and it is determined whether the rotation signal frequency f of the suction fan 36 is equal to or lower than the threshold upper limit value fmax of the target number of rotations (S106). If the rotation signal frequency f of the suction fan 36 is equal to or lower than the threshold upper limit value fmax of the target number of rotations (Y in S106), the feeding operation is started (S107). With this, control is performed such that the sucking/conveying belt 21 is rotated by the first motor 306 (see FIG. 8) and sheets are conveyed.

Next, control is performed such that the suction shutter 37 is closed at predetermined timing after the feeding operation is started (S108) and then, it is determined whether a job is completed (S109). If the job is not completed (N in S109), control is performed such that the suction shutter 37 is opened (S103). If the job is completed (Y in S109), the job is completed.

In S105, if the rotation signal frequency f of the suction fan 36 is smaller than the threshold lower limit value fmin of the target number of rotations (N in S105), it is determined that the suction force of sheets reaches a predetermined suction force. Control is performed such that the number of rotations of the suction fan 36 is increased (UP) (S110). The number of rotations of the suction fan 36 may be increased by a predetermined value by a predetermined value, or by a value obtained by multiplying a shortage by a given coefficient.

Next, the number of rotations of the suction fan 36 is increased and then, it is determined whether the rotation signal frequency f of the suction fan 36 becomes equal to the maximum value Max (S111). If the number of rotations of the suction fan 36 does not become equal to the maximum value (N in S111), i.e., if the PWM value does not reach 100%, it is determined whether the rotation signal frequency f of the suction fan 36 becomes smaller than the threshold lower limit value fmin of the target number of rotations (S105).

The reason why it is determined whether the number of rotations of the suction fan 36 reaches the maximum value is that even if attempt is made to increase the number of rotations of the suction fan 36, the number of rotations of the fan can not further be increased if the fan rotates with the PWM value of 100%.

The number of rotations of the suction fan 36 is increased, and if the rotation signal frequency f becomes greater than the threshold lower limit value fin of the target number of rotations when the rotation signal frequency f of the suction fan 36 is not at the maximum, the procedure is shifted to S106 in a state where a control signal of the fan at that time is maintained.

For example, it is assumed that even if the fan is rotated with the PWM value of 80%, the rotation signal frequency f of the suction fan 36 does not become equal to or higher than the threshold lower limit value fmin of the target number of rotations. In this case, if the PWM value is increased by 1% by 1% and the rotation signal frequency f does not become equal to or higher than the threshold lower limit value fmin of the target number of rotations until the PWM value becomes 84%, control is performed such that the procedure is shifted to S106 in a state where the 84% PWM value is stored and this value is maintained. Then, if the rotation signal frequency f of the suction fan 36 is equal to or less than the threshold upper limit value fmax of the target number of rotations (Y in S106), the feeding operation is started (S107).

In some cases, the rotation signal frequency f of the suction fan 36 is increased (UP) (S110) and the number of rotations of the suction fan 36 reaches the maximum value, i.e., the PWM value reaches 100% (Y in S111). In this case, it is determined that sheets can not be fed, and the series operations are completed. An alarm may be displayed and a user may be informed that sheets can not be fed.

In S106, if the rotation signal frequency f of the suction fan 36 is greater than the threshold upper limit value fmax of the target number of rotations (N in S106), it is determined that the suction force of sheets is greater than the predetermined suction force. In this case, a job is set, but it is determined (S113) whether it is set such that the feeding operation is started even if the rotation signal frequency f of the suction fan 36 is greater than the threshold upper limit value fmax of the target number of rotations (N in S106).

If it is set such that the feeding operation is started even if the rotation signal frequency f of the suction fan 36 is greater than the threshold upper limit value fmax of the target number of rotations, i.e., if it is set such that the operation of the printer 100 is not stopped (Y in S113), control is performed such that sheets are conveyed toward the escape conveying path (S114). In such a case, if it is set such that the operation of the printer 100 is stopped (N in S113), an alarm is displayed on the operation screen (not shown) (S115) and the job is completed.

If it is determined that the number of rotations of the suction fan 36 is in a predetermined range before the sucking/conveying belt 21 is driven as explained above, the sucking/conveying belt 21 is driven, and sheets can reliably be fed without using a sensor such as a pressure sensor. If the sucking state of a sheet is determined from the number of rotations of the suction fan 36, an expensive sensor such as the pressure sensor is unnecessary, and the apparatus can be realized with inexpensive structure.

Next, a second embodiment of the present invention will be explained.

In the second embodiment, when the rotation signal frequency of the suction fan 36 is lower than the threshold lower limit value of the target number of rotations, the PWM value of the suction fan 36 is not renewed, the feeding condition by the sucking/conveying belt 21 is changed, thereby performing control to make it possible to feed sheets. To change the feeding condition by the sucking/conveying belt 21, in this embodiment, at least one of actuation speed, acceleration and conveyance speed of the first motor 306 (see FIG. 8) which drives the belt drive roller 41 is changed.

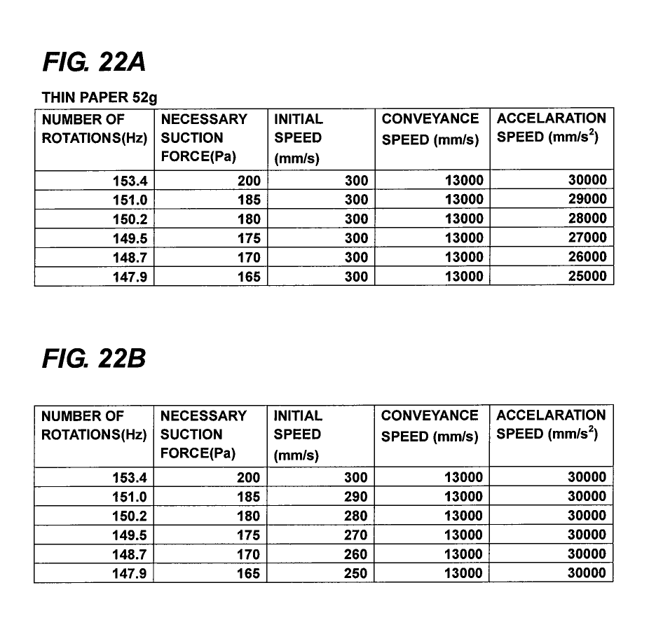

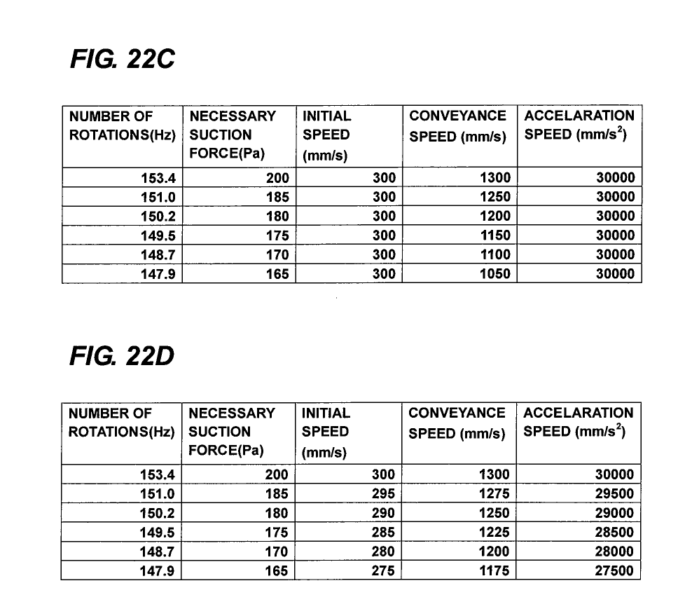

FIG. 22 are tables when a rotation signal frequency of the suction fan 36 does not reach a threshold lower limit value of the target number of rotations when the sucking/conveying belt 21 sucks a thin paper (52 g), wherein (a) shows a table for changing the acceleration, and (b) shows a table for changing initial speed (actuation speed). Further, (c) shows a table for changing conveyance speed of the first motor 306, and (d) shows a table for changing all of acceleration, initial speed (actuation speed) and conveyance speed. The tables shown in FIG. 22 concerning the feeding conditions of the first motor 306 are stored in the memory 303 shown in FIG. 8 as described above.

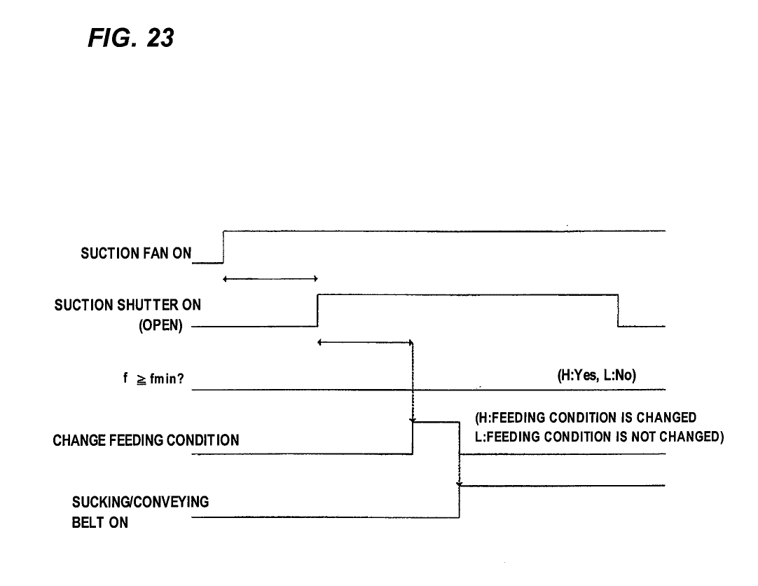

Next, the operation for changing the feeding conditions of the drive system which drives the sucking/conveying belt 21 when a rotation signal frequency f of the suction fan 36 is lower than the threshold lower limit value fmin of the target number of rotations will be explained using a timing chart shown in FIG. 23.

First, control is performed such that suction shutter 37 is turned ON when predetermined time T1 (s) is elapsed after the suction fan 36 is driven (ON), and the suction shutter 37 is opened. Next, a rotation signal frequency f of the suction fan 36 is detected when predetermined time T2 (s) is elapsed after the suction shutter 37 is opened.

Here, when the rotation signal frequency f of the suction fan 36 does not become equal to or higher than the threshold lower limit value fmin of the target number of rotations, the setting of the feeding conditions is changed based on the tables shown in FIG. 22. Then, control is performed such that the sucking/conveying belt 21 is rotated under the changed feeding condition, thereby feeding and conveying a sheet sucked by the sucking/conveying belt 21. Although a feeding state of the first sheet is illustrated in FIG. 23, when a plurality of sheets are to be fed, ON and OFF operations of the suction shutter 37, setting of the feeding condition and ON and OFF operations of the sucking/conveying belt 21 are repeated while keeping the operation state of the suction fan 36.

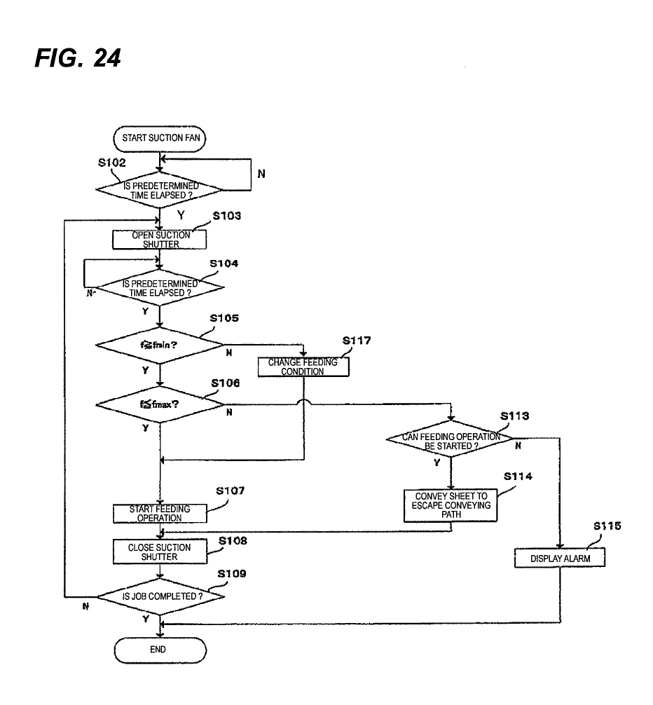

Next, such control will be explained using a flowchart shown in FIG. 24. The flowchart shown in FIG. 24 is different from that shown in FIG. 21 in S117. This portion will be explained below.

If predetermined time is elapsed after the suction shutter 37 is opened (Y in S104), it is determined whether a rotation signal frequency f of the suction fan 36 mounted in the suction duct is equal to or higher than the threshold lower limit value fmin of the target number of rotations (S105). Here, if the rotation signal frequency f of the suction fan 36 is smaller than the threshold lower limit value fmin of the target number of rotations (N in S105), it is determined that the suction force of a sheet does not reach a predetermined suction force.

The ASIC 302 sets such that any or all of actuation speed, acceleration and conveyance speed of the first motor 306 which drives the belt drive roller 41 are changed (S117). Then, the feeding operation is started (S107). With this, the sucking/conveying belt 21 is rotated by the first motor 306 to convey a sheet under the set condition.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-168068, filed Jun. 26, 2007, which is hereby incorporated by reference herein in its entirety.

What is claimed is:

1. An image forming apparatus comprising
an air blowing portion which blows air to sheets stacked on a sheet stacking portion to loosen the sheets;
a conveying belt which sucks the sheet loosened by the air blowing portion and conveys the sheet;
a fan which generates an adsorption force in the conveying belt to suck the sheet;
a rotation number detector which detects number of rotations of the fan; and
a control unit which determines whether the number of rotations of the fan detected by the rotation number detector is in a predetermined range when air is blown to the sheets by the air blowing portion to loosen the sheets and the adsorption force is generated in the conveying belt by the fan, wherein if the control unit determines that the number of rotations of the fan is in the predetermined range, the control unit drives the conveying belt.

2. The image forming apparatus according to claim 1, wherein
when the control unit determines that the number of rotations of the fan is not in the predetermined range, the control unit controls a drive portion of the fan such that the number of rotations of the fan falls within the predetermined range.

3. The image forming apparatus according to claim 2, wherein the control unit includes a type-setting portion which sets a type of the sheet, and a rotation number setting portion which sets the predetermined range in accordance with the type of the sheet set by the type-setting portion, and
the control unit controls the drive portion such that the number of rotations of the fan falls within a predetermined range set by the rotation number setting portion in accordance with the type of the sheet.

4. The image forming apparatus according to claim 2, wherein if the number of rotations of the fan does not fall within the predetermined range when predetermined time is elapsed after the fan starts rotating, the drive portion is controlled.

5. The image forming apparatus according to claim 1, wherein if the number of rotations of the fan does not fall within the predetermined range when predetermined time is elapsed after the fan starts rotating, at least one of actuation speed, acceleration and conveyance speed of the conveying belt is changed.

6. The image forming apparatus according to claim 4, wherein if the number of rotations of the fan does not fall within the predetermined range when predetermined time is elapsed after the fan starts rotating, a warning is sent to an operator.

7. The image forming apparatus according to claim 1, wherein if the number of rotations of the fan exceeds an upper limit of the predetermined range, a sucking/conveying operation of a sheet by the conveying belt is stopped.

8. The image forming apparatus according to claim 7, wherein when the sucking/conveying operation of a sheet by the conveying belt is stopped, a warning that a sheet should be removed is sent to an operator.

9. The image forming apparatus according to claim 7, further comprising a sheet discharge passage through which a sheet is discharged, wherein when the number of rotations of the fan exceeds an upper limit of the predetermined range, a sheet is conveyed to the sheet discharge passage.
